(19) United States
(12) Patent Application Publication
(10) Pub. No.: US 2014/0291550 A1
(43) Pub. Date: Oct. 2, 2014

(54) FLOW CYTOMETER SYSTEMS AND ASSOCIATED METHODS

(71) Applicants: National Institute of Standards and Technology, Gaithersburg, MD (US); The Regents Of The University, a body corporate, Denver, CO (US)

(72) Inventors: Ralph Jimenez, Boulder, CO (US); Richard Erickson, Denver, CO (US)

(21) Appl. No.: 14/242,193

(22) Filed: Apr. 1, 2014

Related U.S. Application Data
(60) Provisional application No. 61/807,174, filed on Apr. 1, 2013.

(51) Int. Cl. G01N 21/64; G01N 15/14

(52) U.S. Cl. CPC G01N 21/6486; G01N 15/1404
USPC 250/459.1; 250/458.1; 250/200

(57) ABSTRACT

A flow cytometer system for algal cells includes a flow cell having an interrogation region, a long wavelength illuminator for illuminating algal cells entering the interrogation region, and a short wavelength illuminator for exciting fluorescence within the algal cells. The system also includes one or more photodetectors for measuring the fluorescence, and a data acquisition system that detects the illuminated algal cells in the interrogation region. The data acquisition system controls the illuminators to provide specific timing and intensity conditions for stimulating to fluorescence, and acquires data from the one or more photodetectors to provide information of the algal cells. The system analyzes data at high speeds to allow it to sort cells based on fluorescence and scattering data.

### RELATED APPLICATIONS

The present document claims priority from U. S. Provisional patent application 61/807,174 filed 1 Apr. 2013, which is incorporated herein by reference it its entirety.

### GOVERNMENT RIGHTS STATEMENT

Work described herein has been supported under National Science Foundation under the Integrative Organismal Systems (IOS)/Early Concept Grants for Exploratory Research (EAGER) program, award number IOS 1044552. The government has certain rights in the invention.

### BACKGROUND

Current methods for measuring the photosynthetic efficiency, growth, and lipid content qualities of algal strains are not ideal. Typically, such methods measure lipid content of small cultures using chromatographic or gravimetric technology, a process that can take days per sample due to the number of cells involved and the time required for the procedure. Biomass researchers seek to resolve questions such as whether a sample includes one broad population or multiple strains having differing productivities, and/or whether cells perform photosynthesis at high rates or efficiencies but without producing lipids. Averaging bulk measurements of live and dead cells prevents the kind of cell-by-cell analysis and data accuracy needed to resolve such questions. It would be desirable to determine which algal strains and conditions will be most efficient for producing biofuels, and more specifically, which strains offer the highest efficiency of photosynthesis with maximal lipid production. Standard flow cytometers do not operate volumetrically, and are thus unable to quantify cell densities. Furthermore, these instruments cannot be configured for photosynthesis measurements. High throughput cell sorters are available, but can subject algal cells to high shear stresses that damage them and thus limit the ability to isolate and expand rare clones in selection experiments.

### SUMMARY

In an embodiment, a flow cytometer system for algal cells includes a flow cell having an interrogation region, a long wavelength illuminator for illuminating algal cells entering the interrogation region, and a short wavelength illuminator for exciting fluorescence within the algal cells. The system also includes one or more photodetectors for measuring the fluorescence, and a data acquisition system that detects the illuminated algal cells in the interrogation region. The data acquisition system controls the illuminators to provide specific conditions for stimulating the fluorescence, and acquires data from the one or more photodetectors to provide information of the algal cells. In a variation, data is analyzed in real time and used to control cell-sorting.

In an embodiment, a flow cytometer system includes a flow cell having an interrogation region; a cell detection subsystem adapted to detect cells entering the interrogation region; a stimulus wavelength illuminator configured to illuminate the interrogation region, and a fluorescence wavelength photodetector, the stimulus wavelength illuminator adapted to provide light of a wavelength suitable for exciting fluorescence within the cells. The system also includes a data acquisition system that is configured to control timing, relative to times of detected cell entry into the interrogation region, of the stimulus wavelength illuminator to provide configurable illumination lengths and intervals adapted to stimulating fluorescence of cells; and is configured to acquire data from the fluorescence wavelength photodetector to provide information of each of the cells.

In another embodiment, flow cytometer system, includes a flow cell having an interrogation region; a detection subsystem adapted to detect cells entering the interrogation region; a stimulus wavelength illuminator configured to illuminate the interrogation region, and a fluorescence wavelength photodetector, the stimulus wavelength illuminator adapted to provide light of a wavelength suitable for exciting fluorescence within the cell. The system also includes a data acquisition system that is configured to control the intensity, at times relative to times of cell entry into the interrogation region, of the illuminators to provide a configurable illumination intensity profile adapted to stimulating fluorescence of cells; and is configured to acquire data from the fluorescence wavelength photodetector to provide information of the given cell.

In another embodiment, a method of analyzing algal cells includes drawing a medium containing cells through an interrogation region of a flow cell; detecting entry of cells into the interrogation region; enabling a stimulus light source having a wavelength associated with at least one component of a photosynthetic system of the cells at a configurable time after detecting entry of cells into the interrogation region; measuring a risetime of fluorescence emissions from the photosynthetic system of the cells; measuring a saturation of fluorescence emissions from the photosynthetic system of the cells; measuring a fluorescent emission of a lipophilic stain; disabling the stimulus light source; analyzing the risetime and saturation of fluorescence emissions the photosynthetic system of the cells in real time; and repeating the steps of detecting, enabling, measuring, and disabling for additional cells drawn through the interrogation region.

### BRIEF DESCRIPTION OF DRAWINGS

FIG. 1 is a block diagram that illustrates functional components of a flow cytometer system for algal cells, in an embodiment.

FIG. 2 is a schematic diagram that illustrates detail of an opto-mechanical subsystem that forms part of the flow cytometer system of FIG. 1.

FIG. 3 is a schematic diagram illustrating components of the microfluidic subsystem of the flow cytometer system of FIG. 1.

FIG. 4 is a flowchart that illustrates a flow cytometry method, in an embodiment.

FIGS. 4A, 4B, 4C, and 4D together form a more detailed flowchart that should be read with FIG. 4.

FIG. 5 is a detailed flowchart of cell detection, data acquiring, data analysis, and sorting.

FIG. 6 is an illustration of risetime of fluorescence of chlorophyll in a particular algal cell.

FIG. 7 is a timeline that illustrates typical timing of actions performed by flow cytometer systems disclosed herein, in an embodiment.

### DETAILED DESCRIPTION OF THE EMBODIMENTS

The present disclosure may be understood by reference to the following detailed description taken in conjunction with the drawings briefly described below. It is noted that, for purposes of illustrative clarity, certain elements in the drawings may not be drawn to scale.

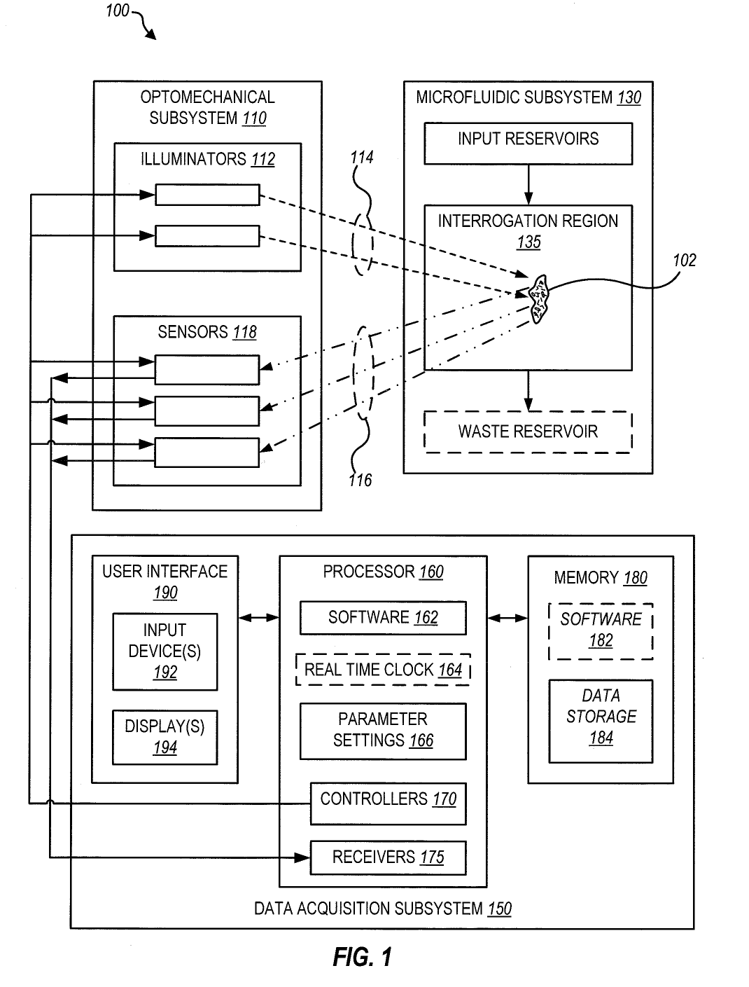

FIG. 1 is a block diagram that illustrates functional components of a flow cytometer system 100, in an embodiment.

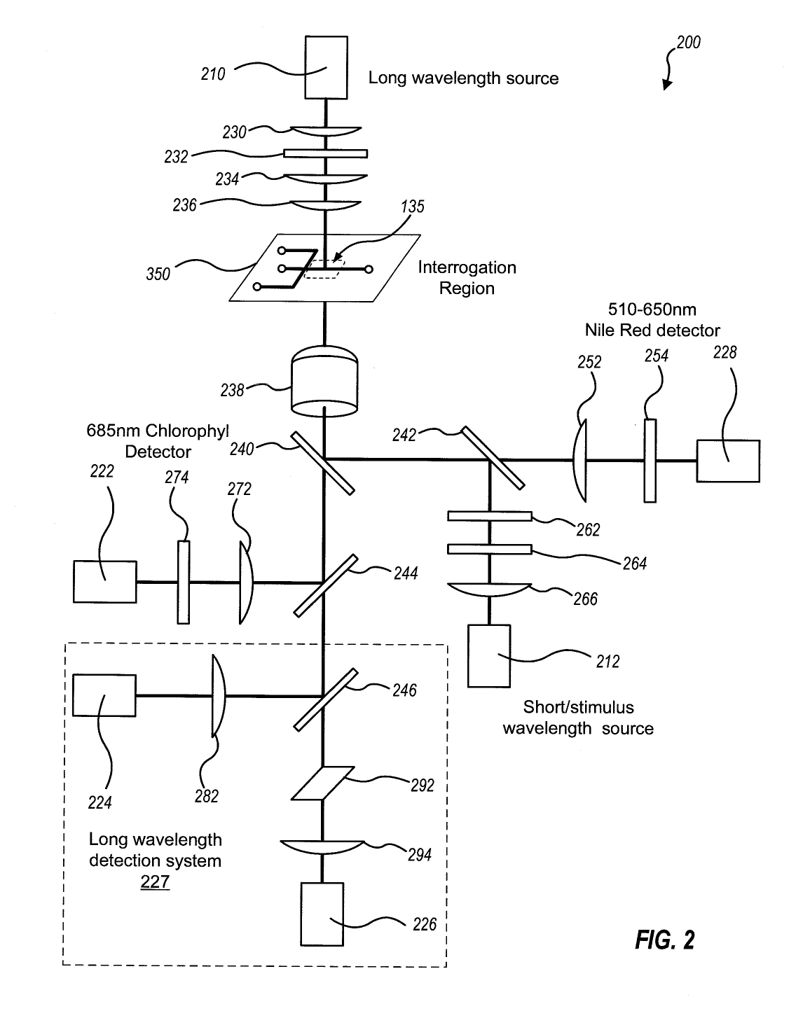

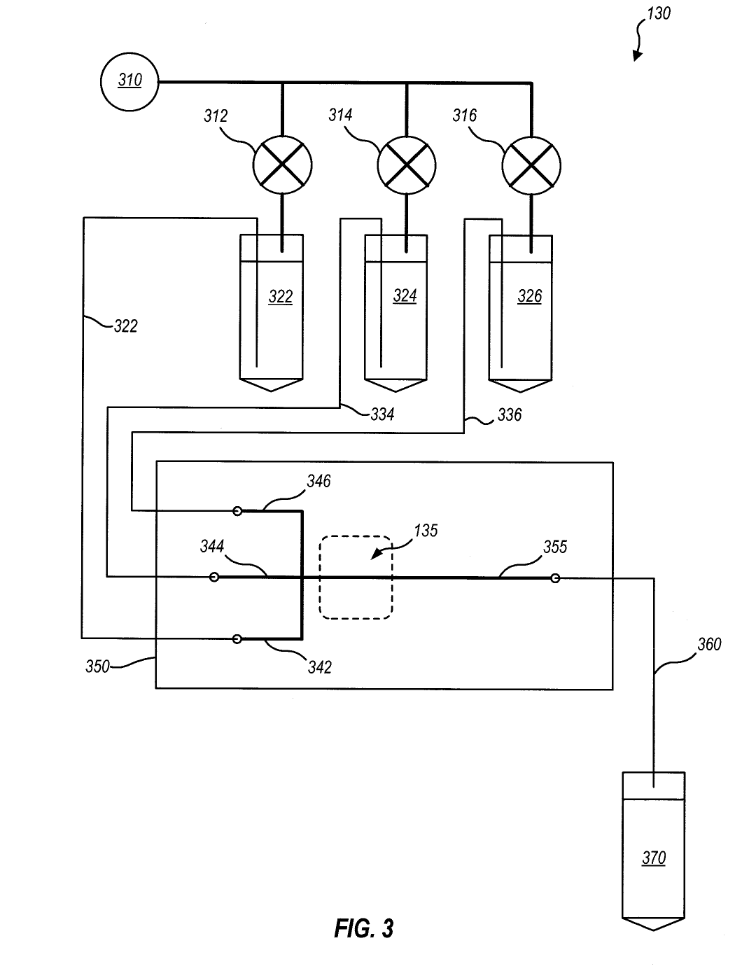

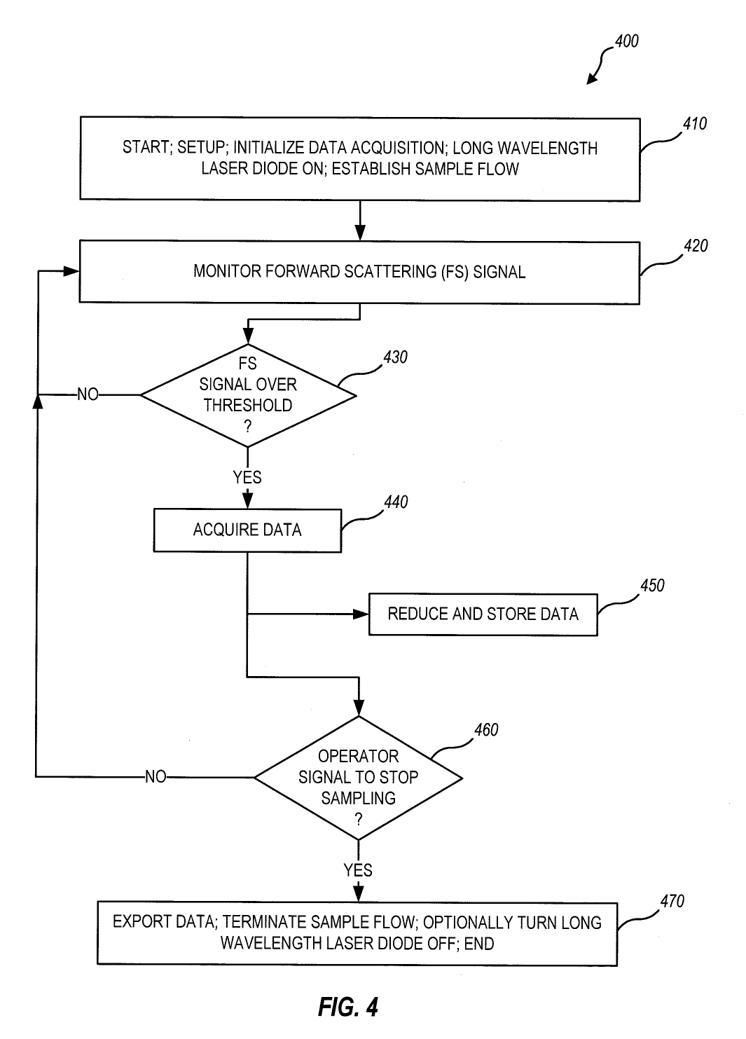

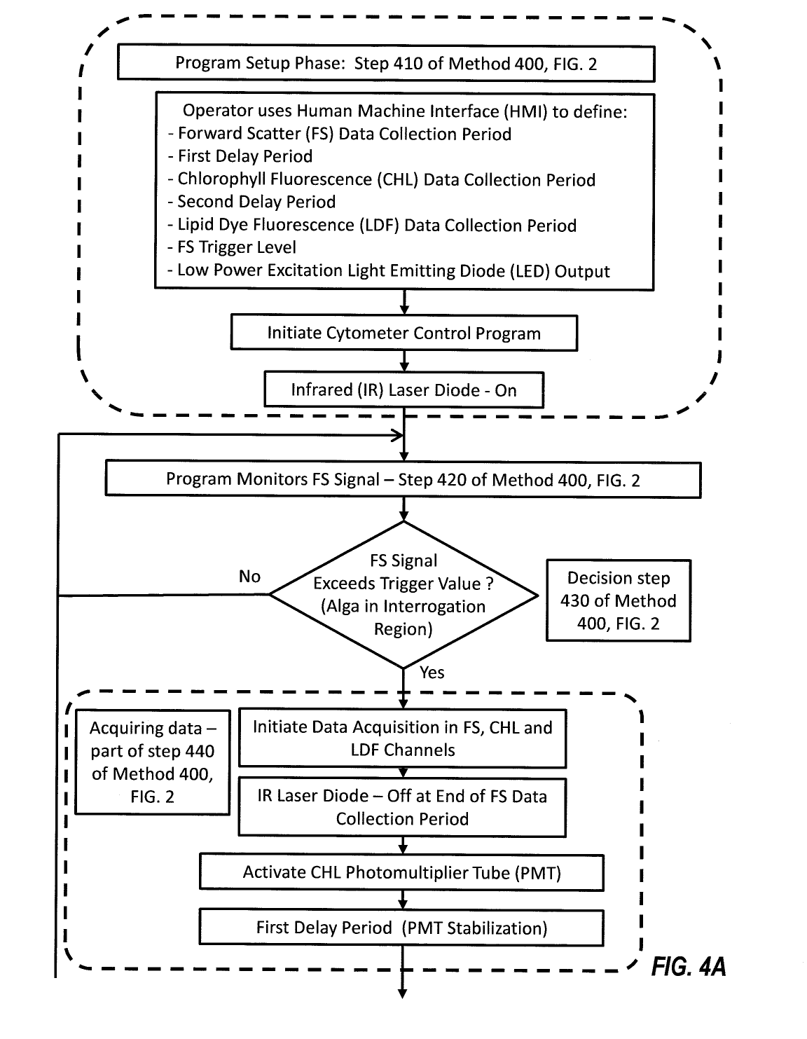

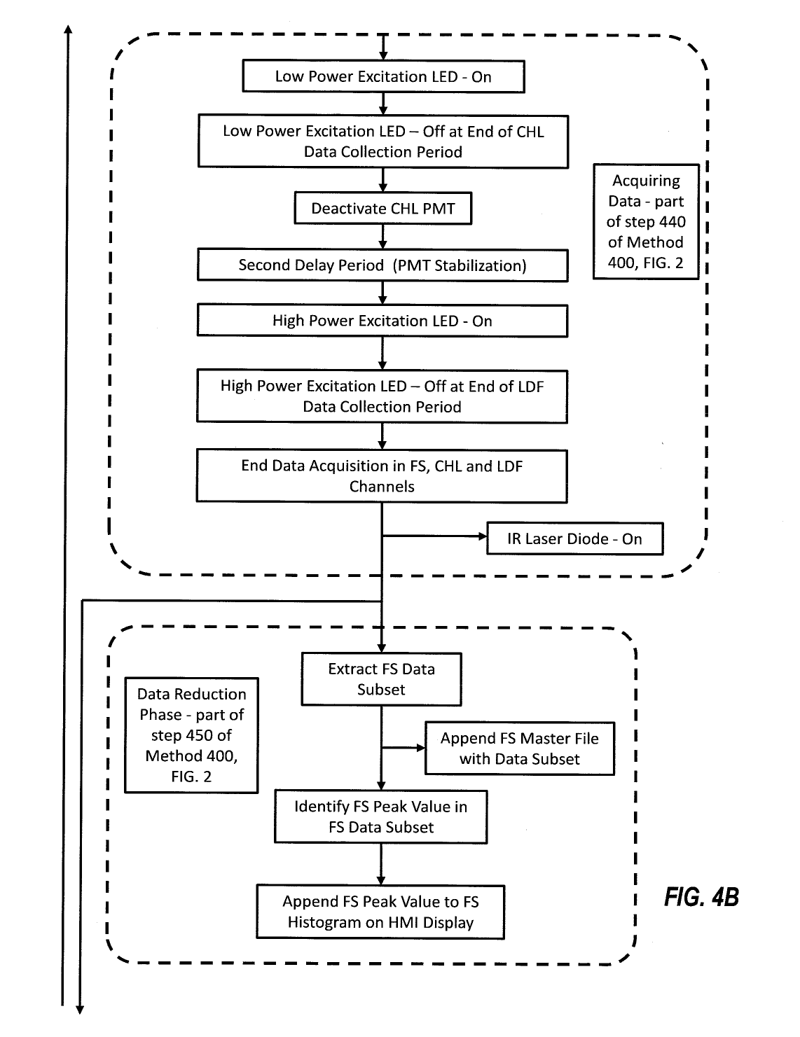

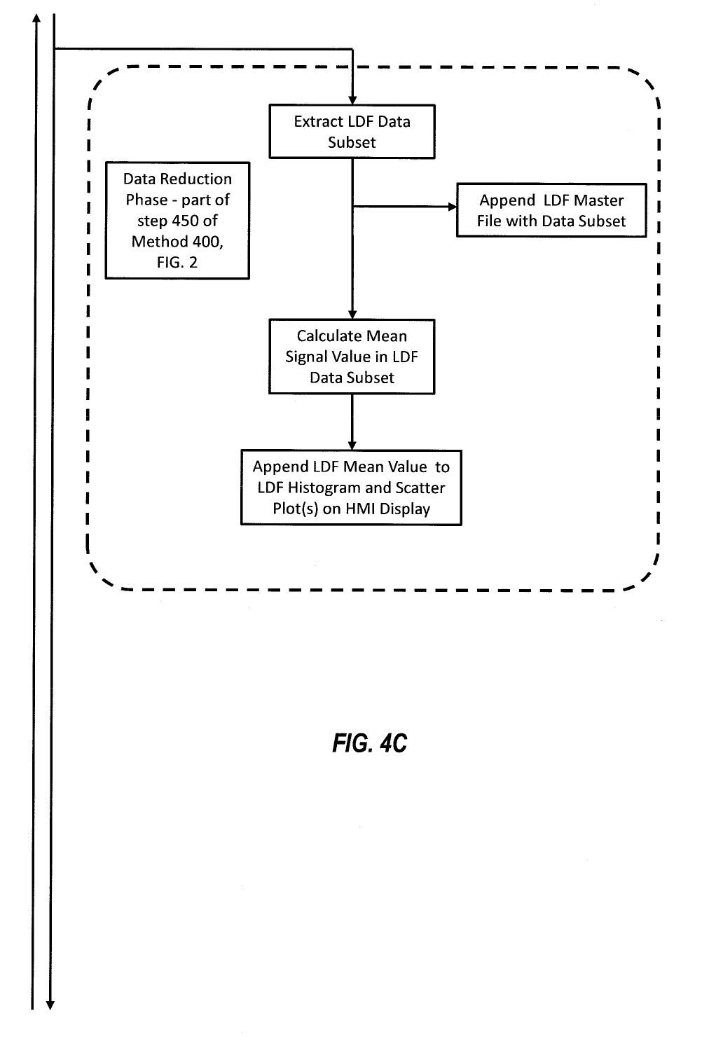

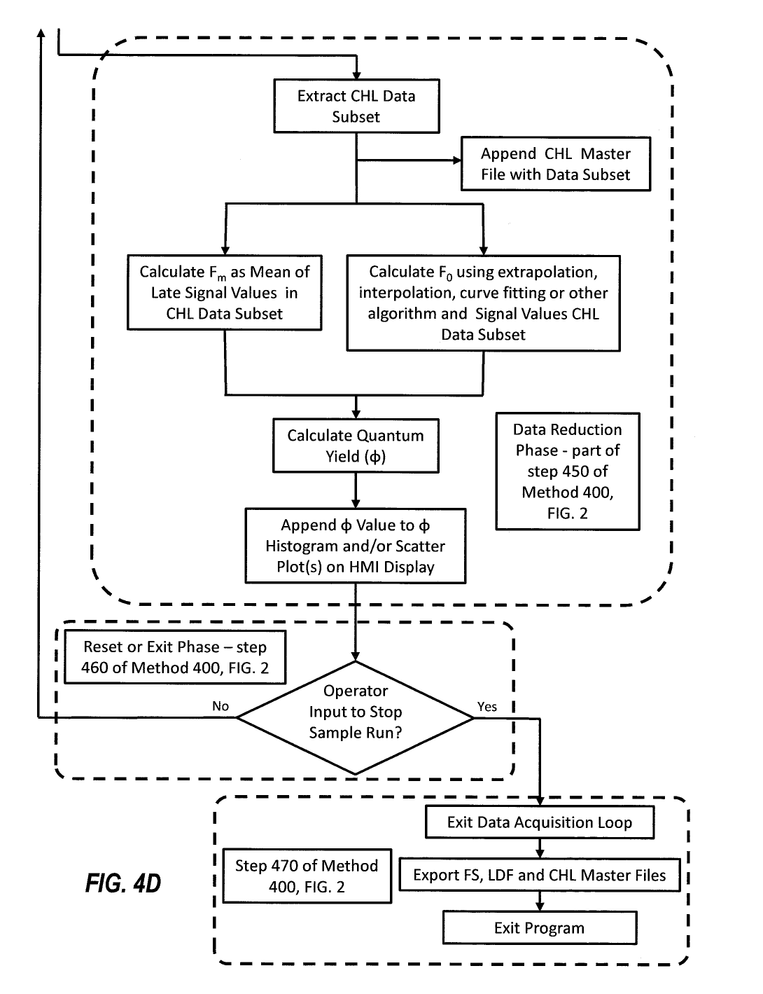

Cytometer system 100 includes at least three subsystems: an opto-mechanical subsystem 110, a microfluidic subsystem 130 and a data acquisition subsystem 150. Opto-mechanical subsystem 110 includes illuminators 112 that provide input light 114 for imaging and/or exciting fluorescence within a cell 102, and sensors 118 for generating corresponding images and for sensing the fluorescence, collectively shown as emitted light 116. Illuminators 112 and sensors 118 are not labeled individually in FIG. 1, but examples thereof are described in detail in FIG. 2; the number of illuminators 112 and sensors 118 shown in FIG. 1 are representative only, more or fewer illuminators 112 and sensors 118 may be utilized. Also, opto-mechanical subsystem 110 includes optical components that are not shown in FIG. 1, but are shown in FIG. 2. Microfluidic subsystem 130 includes an interrogation region 135 where algal cells are individually sensed so that data associated therewith can be generated, as discussed below. Collectively, opto-mechanical subsystem 110 and microfluidic subsystem 130 provide an optical path configuration and alignment for each of algal cell detection, chlorophyll fluorescence measurement channel, and lipid detection channel, which in an embodiment uses Nile Red fluorescence as discussed hereafter.

The activities of opto-mechanical subsystem 110 and microfluidic subsystem 130 are managed by data acquisition subsystem 150 that includes processor 160, memory 180 and a user interface 190. Memory 180 includes data storage 184 and may include software 182 for loading into processor 160. Processor 160 includes, and may run under control of, firmware or software 162 (that may be loaded from software 182 in memory 180). Processor 160 also includes controllers 170 that control the activities of illuminators 112 and sensors 118, and receivers 175 that receive signals from sensors 118. Processor 160 may include a real time clock 164 that provides timing information used by processor 160 to coordinate relative timing of events, as discussed hereinafter, and is recorded along with information received, to form data records corresponding to individual cells that are evaluated. A user of cytometer system 100 interacts through user interface 190 that includes one or more input devices 192 (e.g., a mouse, a keyboard or numeric keypad, touch screens, switches) and one or more displays 194 (e.g., one or more monitors, indicator lights).

The form of data acquisition subsystem 150 is not limited to the exemplary components shown in FIG. 1. For example, input devices 192 may include touch screens or other pointing devices that interact with displays 194 (e.g., as a graphical user interface); processor 160 may run software stored in onboard nonvolatile memory instead of loading from memory 180; controllers 170 and receivers 175 may be implemented in hardware or software. Signals transmitted by sensors 118 may be analog or digital, and when such signals are analog, receivers may include analog-to-digital converters for generating digital data therefrom.

The combination of data acquisition subsystem 150 and opto-mechanical subsystem 110 enables data acquisition not possible with the prior art. For example, these components, acting together, can provide event triggering that detects when a cell is present, and initiates an excitation flash and fluorescence data acquisition such that the fluorescence data is captured on a cell by basis, as discussed further below.

In an embodiment, the cytometer has features including control timing of multiple illuminators, and timing of power output of the illuminators; fully and evenly illuminates the interrogation region with the illuminators; the ability to control timing and sensitivity of photosensors; perform real-time analysis on data acquired from the photosensors; to use mathematical algorithms (such interpolation, extrapolation and curve fitting) in the real-time analysis of the dataset to provide calculations of photosynthetic parameters for each event; to display the results of the real-time analysis in real time; and to perform actions (such as cell sorting) based on the real-time analysis.

Cytometer system 100 incorporates “saturating flash” chlorophyll fluorescence techniques for quantifying photosynthetic performance. A saturating flash produces sufficient light to saturate photoreaction centers, and thus dissipates unused light energy in the form of heat and fluorescence. Measurement of the fluorescence characteristics during the saturating period directly correlates to the quantum yield of the photochemical process. Specifically, fluorescence intensity (F₀) is low when the algal reaction centers are “open” or capable of accepting solar excitation energy, while in the light-saturated state, the reaction centers are “closed” and the fluorescence yield (Fₘ) is maximal. The difference between Fₘ and F₀ is the variable fluorescence (Fᵥ), which when normalized to Fₘ represents the potential quantum yield of photosynthesis (Φ=Fᵥ/Fₘ). The value of Φ ranges from 0 for dead phytoplankton cells to approximately 0.7 for healthy cells.

Lipid content is assessed with lipophilic fluorescent stains; in particular, Nile Red is used to stain neutral and polar lipids in algae. The fluorescence intensity of Nile Red in stained cells correlates linearly with gravimetrically-determined lipid content.

Fluorescence intensity of Nile Red lipid stain, or of another fluorophore, is distinguishable from fluorescence intensity of chlorophyll because peak fluorescent emissions wavelengths of the lipid stain or fluorophore and chlorophyll differ; by choosing an appropriate stimulus wavelength sufficient to excite both the fluorophore and chlorophyll for the illuminator, and differing fluorescent emissions wavelength filters for separate sensors used to measure fluorophore and chlorophyll fluorescence, the two can be measured effectively independently. Sensors 118 therefore provide for spectral separation of chlorophyll and another fluorophore fluorescence emissions. In an alternative embodiment, separate stimulus-wavelength illuminators are provided for chlorophyll and another fluorophore, in a particular alternative embodiment, these separate illuminators are sequentially activated and fluorescence measured for each cell.

FIG. 2 is a block diagram 200 that illustrates components of opto-mechanical subsystem 100 and a microfluidic chip 350 (see FIG. 3) that form part of the flow cytometer system of FIG. 1. A laser diode 210 (which may emit light having a wavelength of about 785 nm) and an LED 212 (which may emit light having a wavelength of about 470 nm) are examples of illuminators 112, FIG. 1. Photomultiplier tubes (“PMTs”) 222 and 228, a photodiode 226 and an imaging system 224 (e.g., a CMOS camera) are examples of sensors 118, FIG. 1. Each of the illuminators 112 and sensors 118 illuminates or captures light, respectively, that passes through or is generated within interrogation region 135 of microfluidic subsystem 130, as now discussed.

In an embodiment, laser diode 210 and long wavelength detection system 227 together operate as a cell detection subsystem adapted to detect cells entering interrogation region 135 of microfluidic subsystem 130, 350. Laser diode 210 provides long wavelength light, having a wavelength beyond an absorbance maximum of chlorophyll and other components of interest of the photosynthetic system of the cells, and thus not significantly absorbed by the photosynthetic system, to interrogation region 135 for general illumination purposes, that is, to provide light for imaging contents of region 135 or to provide a background light level when region 135 presents a clear fluid, as opposed to a cell. In a particular embodiment, laser diode 210 provides light having a first or long wavelength of approximately 785 nanometers wavelength, however it is anticipated that other wavelengths may be used. Light from laser diode 210 passes through focusing and filtering optics between diode 210 and region 135, such as a collimating lens 230, a bandpass filter centered on the first wavelength (in an embodiment where the first wavelength is 785 nm, a 785/10 nm bandpass filter) 232, a cylindrical lens 234 and a focusing lens 236. Long wavelength (e.g., 785 nm) light that passes through or is scattered from contents of microfluidic subsystem passes through a lens 238 (in a particular embodiment lens 238 is a 20× microscope objective lens), a first long pass dichroic mirror 240 (in a particular embodiment a 650 nm long pass dichroic mirror), and a second long pass dichroic mirror 244 (in a particular embodiment a 740 nm long pass dichroic mirror). The long wavelength light eventually arrives at detector of a long-wavelength detection system 227, which in a particular embodiment includes photodiode 226 and/or imaging system 224, as determined by presence or absence of removable mirror 246. In operation, mirror 246 is removed so that first or long wavelength light can proceed past an obscuration bar 292 and through a lens 294 (e.g., a 150 mm focal length lens) to photodiode 226. Photodiode 226 detects a background, long wavelength level of light passing through, or scattering effects thereon caused by cells passing through, interrogation region 135. Output of photodiode 226 is utilized by processor 160 of data acquisition subsystem 150 (FIG. 1), a cell detection signal determining presence of cells in interrogation region 135 for data acquisition. However, during setup of cytometer system 100, removable mirror 246 may be present so that the long wavelength light can pass through a lens (e.g., a 100 mm focal length lens) and be imaged utilizing imaging system 224. Images provided by imaging system 224 may be utilized to help visualize the optical paths of cytometer system 100 for alignment and adjustment purposes, or to photograph contents of interrogation region 135.

In alternative embodiments, cell detection is performed in alternative ways without light-adapting algal cells entering the interrogation region. In one such alternative embodiment, cell detection is performed by monitoring the interrogation region for changes in electrical capacitance caused by cells entering the interrogation region. In another alternative embodiment, cell detection is performed by passing an electric current through the interrogation region and monitoring the interrogation region for changes in electrical resistance of the interrogation region as cells enter the region.

LED 212 emits short wavelength light (e.g., 470 nm light) to induce fluorescence in any cells present in interrogation region 135. For example, chlorophyll may fluoresce with a peak emissions wavelength at about 685 nm, while Nile Red may fluoresce with a peak emissions wavelength at about 525 nm. Light emitted by LED 212 passes through a lens 266 (in a particular embodiment a collimating lens configured to form randomly directed light from the LED into a beam), a diffuser 264 and a filter 262 (e.g., a 470/10 nm bandpass filter). A dichroic mirror (in an embodiment a 510 nm long pass dichroic mirror) 242, and the previously discussed long-wavelength-pass dichroic mirror 240, direct the short wavelength light towards lens 238 and interrogation region 135.

Light induced by fluorescence (as well as longer wavelength light that passes through or scatters from interrogation region 135, as discussed above) is captured by lens 238 and is directed to dichroic mirror 240.

Wavelengths longer than 650 nm pass through mirror 240 and are again be split by mirror 244. Wavelengths longer than 740 nm will pass through mirror 244 for eventual capture by either photodiode 226 or imaging system 224, as discussed above. Wavelengths shorter than 740 nm, including the 685 nm fluorescence peak of chlorophyll, will be reflected by mirror 244 to PMT 222, also denoted “CHL PMT” herein. A lens 272 (e.g., a 100 mm focal length lens) and a bandpass filter (e.g., a 685/40 bandpass filter) is utilized to focus and filter the light reaching PMT 222, for example to maximize light capture, but limit the light to the chlorophyll fluorescence peak wavelength range.

Wavelengths shorter than 650 nm are reflected by mirror 240. Reflected 470 nm light and other stray, short wavelength light are reflected by mirror 242 back towards LED 212, while light of wavelengths between 510nm (or, the lower limit of long pass dichroic mirror 242) and 650 nm (or, the lower limit of long pass dichroic mirror 240) continue on towards a Nile Red Detector, PMT 228, also denoted “Nile Red PMT” herein. A lens 252 (e.g., a 100 mm focal length lens) and a filter (e.g., a 583/120 nm bandpass filter) are used to focus and filter the light reaching PMT 228. Thus, when material in interrogation region 135 includes the Nile Red dye and fluoresces around a typical wavelength of 525 nm or higher, the light emitted reaches PMT 228.

In alternative embodiments, scatter light can be detected by substituting the long wavelength illuminator 210 with a stimulus-wavelength illuminator; locating an additional long pass dichroic mirror (that does not pass stimulus wavelength illumination) between lens 238 and the first long pass dichroic mirror 240; and relocating obscuration bar 292, lens 294 and photodiode 226 into the deflected stimulus-wavelength optical pathway. Photodiode 226 then detects a background, stimulus-wavelength level of light passing through, or scattering effects thereon caused by cells passing through, interrogation region 135.

FIG. 3 is a schematic diagram illustrating components of microfluidic subsystem 130. A filtered air supply 310 provides pressurized air to regulators 312, 314 and 316. Regulated pressurized air is thus provided to a lower sheath reservoir 322, a sample reservoir 324 and an upper sheath reservoir 326, as shown. In certain embodiments, an operator of system 100 manually controls settings of regulators 312, 314 and 316; however, in other embodiments regulators 312, 314 and 316 are electronically controlled by data acquisition subsystem 150. The regulated pressurized air pushes fluids from each of the reservoirs into a lower sheath line 332, a sample line 334 and an upper sheath line 336 respectively; these lines connect with a lower sheath channel 342, a sample channel 344 and an upper sheath channel 346 respectively, on a microfluidic chip 350. Channels 342, 344 and 346 meet such that the respective flows of the channels merge to form a hydrodynamically focused sample stream 355 that passes through interrogation region 135 shown in FIGS. 1 and 2. In embodiments, interrogation region 135 is a 50 μm or 100 μm channel and 1.3 mm long; these dimensions may vary by a factor of 5 or more if other components of cytometer system 100 are scaled appropriately (e.g., a field of view of lens 238 must cover interrogation region 135). After data is taken in interrogation region 135, sample stream 355 empties into a waste line 360 that in turn empties into a waste reservoir 370.

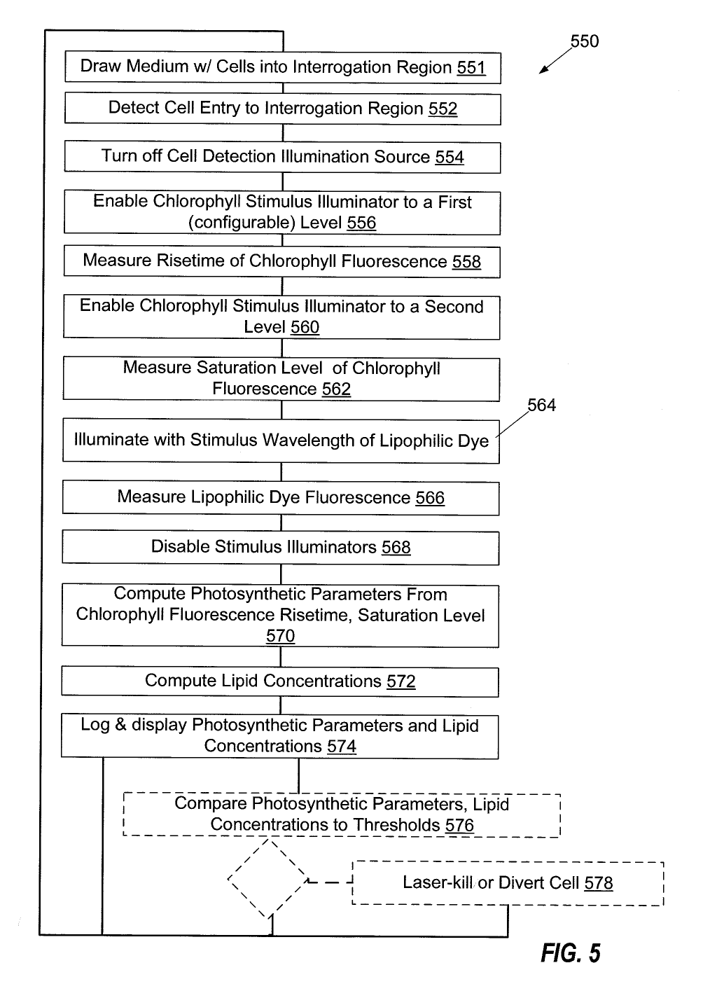

FIG. 4 is a flowchart that illustrates an embodiment of a flow cytometry method 400 adapted for analyzing algae. In step 410, a flow cytometer (e.g., system 100, FIG. 1) is set up; for example a sample to be analyzed is loaded into a sample reservoir of the cytometer; a data acquisition system of the cytometer is initialized; a long wavelength laser diode of a cell detection subsystem is turned on to illuminate an interrogation region of the cytometer; flow of the sample and sheath liquids through interrogation region 135 is established. In step 420, a forward scattering (“FS”) signal of the cytometer is monitored as part of cell detection. As long as the FS signal remains below a predetermined threshold, step 430 sends method 400 back to step 420 to continue monitoring the FS signal. When step 430 determines that the FS signal is over its threshold, indicating a cell is detected in the interrogation region, method 400 proceeds to step 440, wherein data is acquired. Further details of step 440 are provided in with reference to FIG. 5 below; in general, step 440 involves controlling illuminators 112 to induce fluorescence in a detected cell, and measuring such fluorescence. When step 440 is complete, method 400 begins a step 450, wherein the data acquired in step 440 is reduced and stored. Step 450 only involves processing resources of data acquisition subsystem 150, and is done in parallel with method 400 proceeding to step 460. In decision step 460, if an operator signal to stop sampling is detected, method 400 proceeds to step 470, otherwise method 400 returns to step 420 to continue monitoring the FS signal. In step 470, the long wavelength laser diode is turned off, the data gathered and stored in steps 440 and 450 is exported, and method 400 ends.

The flow cytometer has a processor to perform real-time analysis of this dataset. This real-time analysis may use mathematical algorithms (such as interpolation, extrapolation and curve fitting) in the real-time analysis of the dataset to provide measurements of photosynthetic parameters for each event. The initial and final chlorophyll fluorescence of the photosystem are used to calculate photosynthetic parameters such as quantum yield values. Theoretical modeling of chlorophyll fluorescence yield has been previously described using the Stern-Volmer equation. Olson et al. have used this model, although not in real-time during flow cytometry, to show that fluorescence yield of dark adapted algal cells follows an exponential increase when exposed to continuous light excitation. Using this approach combined with a least-squares nonlinear regression technique, they were able to estimate both the quantum yield of photochemistry in photosystem II and functional absorption cross-section of the photosystem II reaction center. The flow cytometer performs a real-time analysis of the dataset, and in doing so may use a modeling technique similar to that described by Olson et al (,- R J Olson, H M Sosik, A M Chekalyuk, Photosynthetic characteristics of marine phytoplankton from pump-during-probe fluorometry of individual cells at sea., Cytometry. 1999 Sep. 1; 37 (1):1-13 10451501) or a linear extrapolation model using as few as two data points to provide an approximation of F0 values. The flow cytometer is not limited to these two methods and could incorporate multiple alternative mathematical algorithms for approximation of F0 values or other photosynthetic parameters. The flow cytometer is adapted to display cumulative plots of determined parameters on displays 194 in real time.

An alternative embodiment of a method 550 for filtering algal cells by photosynthetic efficiency and lipid production, including a variation of steps 420, 430, 440, and 450, is detailed in FIG. 5, In embodiments, the algal cells may be cyanobacteria or “blue-green” algae, or single-celled “green” algae of chlorophyta or charophyta. After setup, a culture medium containing the algal cells and lipophilic dye is drawn 551 slowly through the interrogation region with any illuminator of a cell detection subsystem turned on. As the algal cells enter the interrogation region 135, their arrival in the interrogation region is detected 552 by the cell detection subsystem, After detection of each algal cell, any light source used by the cell detection subsystem is optionally turned off 554 to avoid interference with fluorescence measurement; in a particular embodiment, prior to turning off this light source, light of the wavelength of the light source used by the cell detection subsystem and scattered by the cell is measured, and the measurement is recorded.

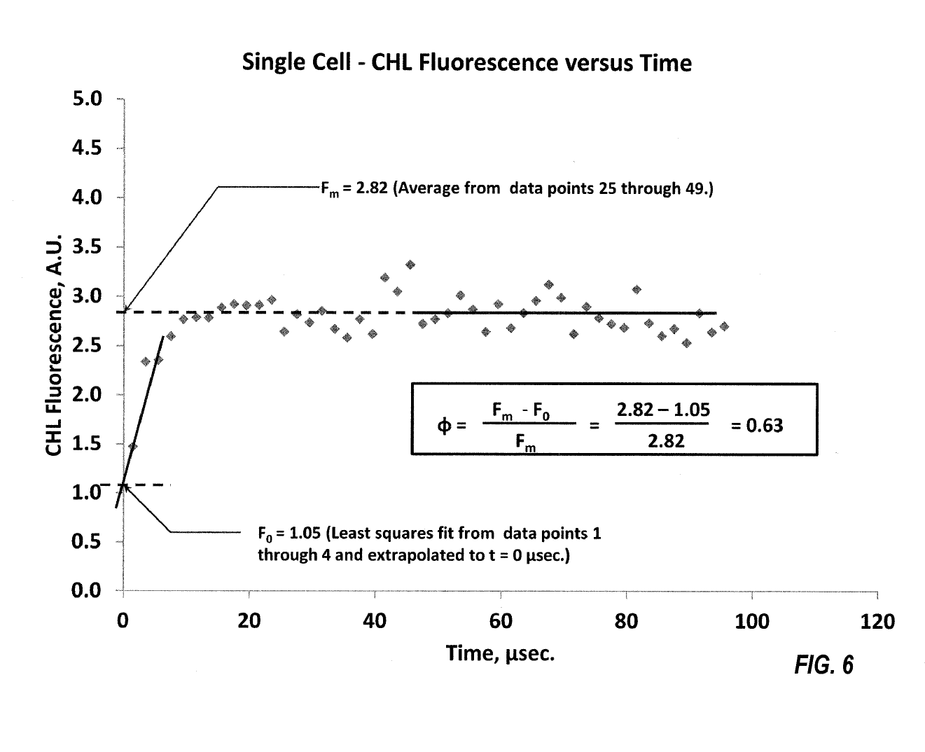

At least one stimulus light source or illuminator 212 is then turned 556 on sharply at a first, low, intensity determined to activate fluorescence emissions of chlorophyll or other components of the photosynthetic system slowly enough that it is practical to measure 558 a fluorescence risetime with sequential measurements taken with chlorophyll emissions photodetector 222; an example risetime of chlorphyll fluorescent emissions is illustrated in FIG. 6. In an embodiment, illuminator 212 has wavelength absorbable by chlorophyll, in alternative embodiments it has a wavelength adapted for absorption by other components of the photosynthetic system of the cells. It is preferable that the first intensity be non-zero and produce a fluorescent emissions risetime in the range twenty to one hundred microseconds, and the first intensity is therefore user configurable or adjustable. Measurement of the risetime is performed by repetitively measuring fluorescent emissions at intervals, in a particular embodiment at two microsecond intervals, for at least one time constant of the risetime such that a risetime can be calculated by performing a least-squares fitting of parameters of an equation to measured fluorescent light intensity data. Light source or illuminator 212 is then enabled 560 to a second, higher, non-zero intensity to permit detector 222 and acquisition system 150 to measure 562 a saturation level of fluorescence emissions from the chlorophyll.

In an embodiment, sensitivity of detector 222 is reduced as illuminator 212 is enabled to the second, higher, intensity to avoid saturation of the detector, detector sensitivity is returned to a high sensitivity when data gathering for a particular cell ends and the stimulus wavelength illuminator is turned off, and the system waits for detection of the next cell. In embodiments, the detector may be disabled when not in use to protect photomultiplier tubes (PMT) or other high sensitivity components of the detector.

In a particular embodiment using PMTs, the PMT on-state is directly controlled by the data acquisition system but is indirectly control by the user when the chlorophyll data collection period and saturation sampling intervals are specified. Though traditional cytometers have not previously employed gated light sensors, this capability may have broad applications within the field of cytometry. Gated light sensors could be used anytime multiple light excitation sources are employed that have large differences in power density or when the intensity of emission signals in each of the channels is not of similar magnitude. In this embodiment, the flow cytometer incorporates a fast gating circuit (nsec to μsec rise times) that adjusts the PMT dynode potentials to reduce or prevent electron multiplication but additional methods such as switching photocathode potentials, mechanical shutters or electro-optic modulators could also be employed in alternative embodiments.

In a particular embodiment, stimulus-wavelength light scattered by the algal cell in the interrogation region is detected and measured at each interval and at saturation, those measurements are recorded.

In embodiments having a separate stimulus illuminator at a stimulus wavelength associated with lipophilic dye, a lipophilic dye illuminator is then turned on 564 and lipophilic dye emissions are measured 566. In embodiments, such as that illustrated in FIG. 2, with common illumination for both chlorophyll and lipophilic dye, the common stimulus illuminator is left on until after lipophilic dye emissions are measured 566. The stimulus illuminator is then turned off 568. Steps 556 to 568 may optionally be repeated if flow rates through the interrogation region are sufficiently low.

Data corresponding to risetime and saturation levels of chlorophyll fluorescence, and of lipophilic dye fluorescence, are then rapidly analyzed. In an embodiment, analysis of risetime and saturation levels is performed using a least-squares fit. Lipid concentrations are also computed from the lipophilic dye emissions measurements. Data corresponding to computed risetime and saturation, and lipid concentrations is then logged 574 for each cell interrogated.

In some embodiments, optional cell-sorting is enabled. When cell sorting is enabled, the data corresponding to computed risetime and saturation and lipid concentrations is compared to limits, and for cells not meeting limits set a high intensity laser is used to kill those cells, or an electromechanical subsystem is used to divert 578 those cells into a waste tank instead of a collection chamber.

In alternative embodiments, a spectrographic detector (not shown) is used in place of separate detectors 222, 228, 224, 226. Such a spectrographic detector may be formed from a spectrally dispersion device such as a prism or diffraction grating that is illuminated by incoming light, the spectrally dispersion device directing light in separated spectral bands onto multiple photodetectors, such as a photosensor array integrated circuit, in a manner such that fluorescent light from lipophilic dye and fluorescent light from chlorophyll or other components of the photosynthetic system illuminate separate photodetectors of the photo sensor array.

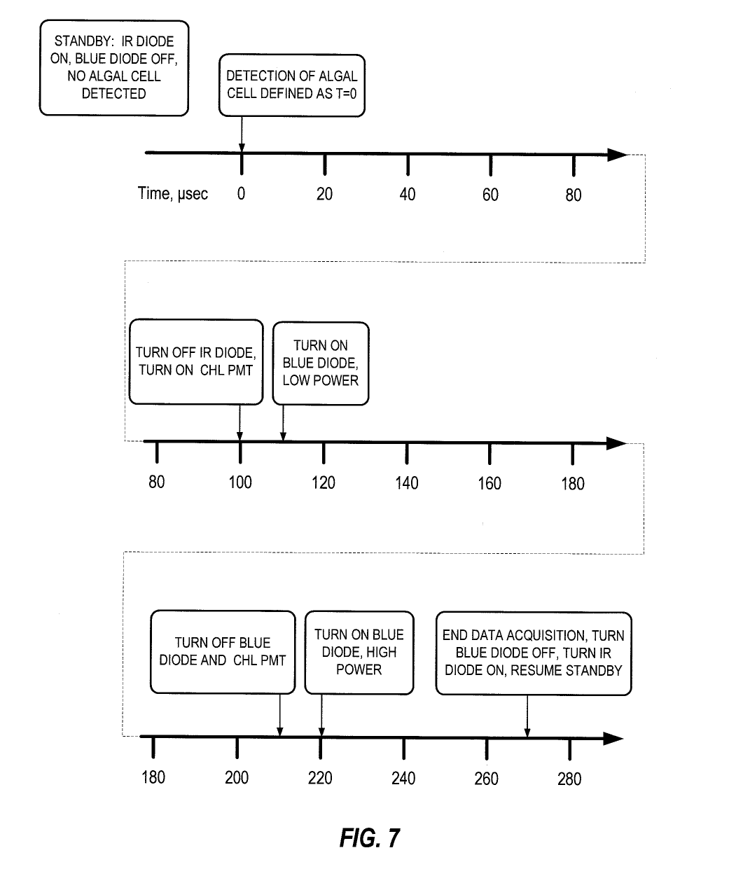

FIG. 7 is an approximate timeline that illustrates typical timing of actions performed by flow cytometer systems disclosed herein, in an embodiment. It should be noted that automated detection of cells, illumination with stimulus illuminators with rapid response times (such as laser diodes and LEDs) and using electronic control over all aspects of the flow cytometer, the data collection sequence for a given cell is far less than one millisecond. This provides several advantages: (1) it enables cell-by-cell data collection, and enables data acquisition for large cell populations within reasonable time; (2) data collection occurs much faster than transit of a given cell through interrogation region 135, so that flow of the sample through the interrogation region need not be halted while measurements are done; and (3) it enables cell sorting, either by manipulating waste line 360 to divert individual cells to different destinations, or by selective cell destruction such that the only live cells that enter waste line 360 are of a specific type; these cells may then be collected and cultured. Selective cell destruction may be accomplished, for example, by utilizing either or both of illuminators 112 (e.g., laser diode 210 and/or LED 212) at very high power, or an additional laser may be added to the system to perform cell destruction.

It should be noted that a delay from cell detection to recording scatter data at the first detection wavelength, and turning off the long wavelength illuminator 210, and before turning on the stimulus wavelength illuminator at the low level is user configurable either through a user interface of the data acquisition system or through a configuration file that may be edited and uploaded from a host computer. Further, sampling width and period of the multiple fluorescence measurements used to determine risetime of chlorophyll fluorescence, for phase-sensitive detection or spectrographic detection as illustrated in FIG. 6, are also configurable. Similarly, a delay from the turning on the stimulus wavelength illuminator to the low level to setting it to the high level used for measuring saturation chlorophyll fluorescence, and a delay to measurements of the saturation chlorophyll fluorescence is also user configurable, as is a delay from turning the stimulus wavelength illuminator to high level or turning on a lipophilic dye illuminator (in embodiments so equipped) to measurement of the lipophilic nile-red dye fluorescence.

The term “stimulus wavelength illuminator configured to illuminate the interrogation region, and a fluorescence wavelength photodetector” as used herein corresponds to a combination of a stimulus light source and a photodetector, that are either frequency selective or combined with wavelength-selective components of an optical path associated with the light source and photodetector. The photodetector and wavelength-selective components are configured such that that light of at least a fluorescence wavelength emitted in the interrogation region is detectable by the photodetector, but light emitted by the stimulus light source is prevented from detection by the photodetector. The light source, and wavelength selective components (if any), are configured such that light of at least a particular stimulus wavelength is both emitted by the light source and allowed into the interrogation region, but, no light of fluorescence wavelength is permitted to enter the interrogation region from the stimulus light source. It is anticipated that the light source may be either monochromatic, or wavelength selective components such as filters, dichroic mirrors, prisms, or diffraction gratings be provided in the optical path. Similarly, it is anticipated that wavelength selective components such as filters, dichroic mirrors, prisms, or diffraction gratings are provided in a path from interrogation region to photodetector.

The changes described above, and others, may be made in the flow cytometer systems and methods described herein without departing from the scope hereof. Variations may include applying these systems and methods to cells other than algal cells, and/or adding cell sorting and/or cell destroying capability to such systems. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A flow cytometer system, comprising:
a flow cell having an interrogation region;
a cell detection subsystem adapted to detect cells entering the interrogation region;
a stimulus wavelength illuminator configured to illuminate the interrogation region, and a fluorescence wavelength photodetector, the stimulus wavelength illuminator adapted to provide light of a wavelength suitable for exciting fluorescence within the cells; and
a data acquisition system that
is configured to control timing, relative to times of detected cell entry into the interrogation region, of the stimulus wavelength illuminator to provide configurable illumination lengths and intervals adapted to stimulating fluorescence of cells; and
is configured to acquire data from the fluorescence wavelength photodetector to provide information of each of the cells.

2. The system of claim 1, wherein the stimulus wavelength illuminator is adapted to fully illuminate the interrogation region.

3. The system of claim 1, wherein the data acquisition system is adapted to control a sensitivity of the light sensors.

4. The system of claim 1, wherein the data acquisition system is configured to capture multiple fluorescence measurements as the data for each cell.

5. The system of claim 1 wherein data acquisition system is configured to perform real-time analysis on the data for each cell.

6. The system of claim 5 wherein the system is configured to perform risetime analysis of data from the fluorescence wavelength photodetector.

7. The system of claim 5, wherein the system is adapted to perform cell sorting using results of the realtime analysis results

8. The system of claim 1 wherein the system is configured to provide at least a first and a second nonzero intensity levels of the stimulus illuminator for each cell, with at least the first intensity being configurable.

9. The system of claim 1 wherein the cell detection subsystem has a detection illuminator operating at a detection wavelength, and wherein the system is configured to capture scattering data of light scattering at the detection wavelength for each of the cells.

10. A flow cytometer system, comprising:
a flow cell having an interrogation region;
a detection subsystem adapted to detect cells entering the interrogation region;
a stimulus wavelength illuminator configured to illuminate the interrogation region, and a fluorescence wavelength photodetector, the stimulus wavelength illuminator adapted to provide light of a wavelength suitable for exciting fluorescence within the cell; and
a data acquisition system that
is configured to control the intensity, at times relative to times of cell entry into the interrogation region, of the illuminators to provide a configurable illumination intensity profile adapted to stimulating fluorescence of cells; and
is configured to acquire data from the fluorescence wavelength photodetector to provide information of the given cell.

11. The system of claim 10, wherein the stimulus wavelength illuminator is adapted to fully illuminate the interrogation region.

12. The system of claim 10, wherein the data acquisition system is adapted to control a sensitivity of the light sensors.

13. The system of claim 10, wherein the data acquisition system is configured to capture multiple fluorescence measurements as the data for each cell.

14. The system of claim 10 wherein data acquisition system is configured to perform real-time analysis on the data for each cell.

15. The system of claim 14 wherein the system is configured to perform risetime analysis of data from the fluorescence wavelength photodetector.

16. The system of claim 14, wherein the system is adapted to perform cell sorting using results of the realtime analysis results

17. The system of claim 10 wherein the system is configured to provide at least a first and a second nonzero intensity levels of the stimulus illuminator for each cell, with at least the first intensity being configurable.

18. The system of claim 10 wherein the cell detection subsystem has a detection illuminator operating at a detection wavelength, and wherein the system is configured to capture scattering data of light scattering at the detection wavelength for each of the cells.

19. A method of analyzing algal cells comprising:
drawing a medium containing cells through an interrogation region of a flow cell;
detecting entry of cells into the interrogation region;
enabling a stimulus light source having a wavelength associated with at least one component of a photosynthetic system of the cells at a configurable time after detecting entry of cells into the interrogation region;
measuring a risetime of fluorescence emissions from the photosynthetic system of the cells;
measuring a saturation of fluorescence emissions from the photosynthetic system of the cells;
measuring a fluorescent emission of a lipophilic stain;
disabling the stimulus light source;
analyzing the risetime and saturation of fluorescence emissions the photosynthetic system of the cells in real time; and
repeating the steps of detecting, enabling, measuring, and disabling for additional cells drawn through the interrogation region.

20. The method of claim 19 wherein the risetime and saturation of fluorescence emissions of the photosynthetic system of the cells and fluorescence emissions of a lipophilic stain are measured at different levels of the stimulus light source.

21. The method of claim 20 further comprising sorting cells based upon information comprising results of analyzing the risetime.

22. The method of claim 19 wherein the component of the photosynthetic system is chlorophyll.

23. The method of claim 19 wherein measuring a fluorescent emission of a lipophilic stain is performed using a second fluorescent light source, the second fluorescent light source being inactive while the fluorescent emissions from the photosynthetic system are measured.

24. The method of claim 19 wherein the measuring of a risetime is performed by fitting parameters of an equation to a sequence of fluorescence measurements.

25. The method of claim 19 wherein the detecting entry of cells into the interrogation region is performed by illuminating the interrogation region with light not significantly absorbed by the photosynthetic system of the cells, and detecting scatter of that light.
